(19) United States
(12) Patent Application Publication
(10) Pub. No.: US 2012/0033315 A1
(43) Pub. Date: Feb. 9, 2012

(54) SCANNER MOTOR

(75) Inventors: Sang Jae Song, Gyunggi-do (KR); Song Bon Oh, Gyunggi-do (KR)

(73) Assignee: SAMSUNG ELECTRO-MECHANICS CO., LTD., Gyunggi-do (KR)

(21) Appl. No.: 13/198,517

(22) Filed: Aug. 4, 2011

(30) Foreign Application Priority Data
Aug. 6, 2010 (KR) 1020100076065

(51) Int. Cl. G02B 26/12

(52) U.S. Cl. 359/876

(57) ABSTRACT

Disclosed herein is a scanner motor, including: a rotor case fixed on a rotation shaft to be rotated; a polygon mirror mounted on a top of the rotor case; and a bonding part formed between the rotor case and the polygon mirror to fix the polygon mirror on the rotor case.

### CROSS REFERENCE TO RELATED APPLICATION

This application claims the benefit of Korean Patent Application No. 10-2010-0076065, filed on Aug. 6, 2010, entitled “Scanner Motor” which is hereby incorporated by reference in its entirety into this application.

### BACKGROUND OF THE INVENTION

1. Technical Field

The present invention relates to a scanner motor.

2. Description of the Related Art

The present invention relates to a scanner motor used in an output device using an optical technology, such as a laser beam printer or a scanner, to rotate a polygon mirror. As the market for an output device using an optical technology is leading to compactness and high speed, there is a demand for increased performance in an actuator driving an optical reflective device, which is a core component such as a polygon mirror.

At present, a polygon mirror applied to a polygon scanner motor has been manufactured by mechanically machining aluminum (Al).

In addition, due to a continuous shortage of a polygon mirror in the current market, a manufacturing method using glass has been considered as a solution. However, there has been a difficulty in generating a central hole through which the polygon mirror is connected to a rotary body.

In other words, the polygon mirror according to the prior art is formed with a hole for assembling in the center thereof, and is assembled with a rotary body based on the hole.

Through the structure, the polygon mirror may be assembled relatively simply and precisely with the rotary body but a central hole must be formed in the polygon mirror, thereby causing problems in that manufacturing costs are increased and the manufacturing methods are limited.

### SUMMARY OF THE INVENTION

The present invention has been made in an effort to provide a scanner motor with a simple manufacturing process and high product reliability of a product by mounting and bonding a rectangular parallelepiped polygon mirror on a top of a rotor case.

A scanner motor according to a preferred embodiment of the present invention includes: a rotor case fixed on a rotation shaft to be rotated; a polygon mirror mounted on a top of the rotor case; and a bonding part formed between the rotor case and the polygon mirror to fix the polygon mirror on the rotor case.

Herein, the polygon mirror may have a rectangular parallelepiped shape.

The rotor case may be formed with a step part, wherein the step part is formed on an outer circumferential portion so that it corresponds to an outer circumferential portion of the polygon mirror.

Edges of the polygon mirror may be in contact with the step part of the rotor case.

The bonding part may be applied with a bonding agent or an adhesive.

The polygon mirror may be made of glass or plastic.

The rotor case may be formed with a groove part in which the bonding agent is filled so that the polygon mirror is fixed on the contact surface with the polygon mirror.

### BRIEF DESCRIPTION OF THE DRAWINGS

FIG. 1 is a partial perspective view of a scanner motor according to a preferred embodiment of the present invention;

FIG. 2 is a partial cross-sectional view of a scanner motor according to a preferred embodiment of the present invention; and

FIG. 3 is a partial enlarged view of a scanner motor according to a preferred embodiment of the present invention.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, a scanner motor according to preferred embodiments of the present invention will be described in detail with reference to the accompanying drawings.

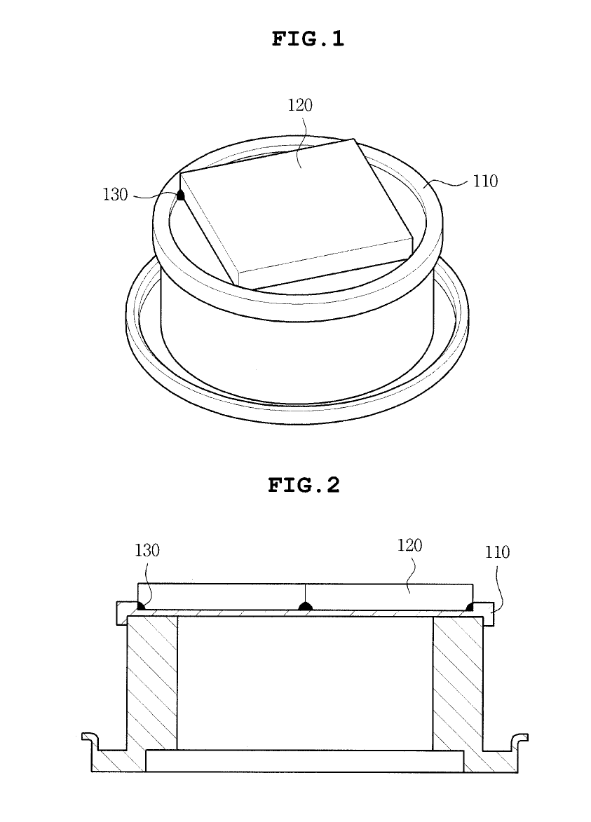

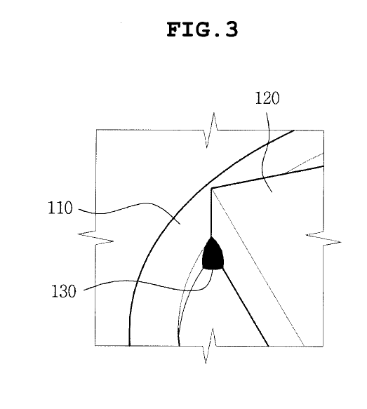

FIG. 1 is a partial perspective view of a scanner motor according to a preferred embodiment of the present invention, FIG. 2 is a partial cross-sectional view of a scanner motor according to a preferred embodiment of the present invention, and FIG. 3 is a partial enlarged view of a scanner motor according to a preferred embodiment of the present invention.

First, FIG. 1 shows a partial perspective view of a scanner motor according to a preferred embodiment of the present invention, wherein the scanner motor includes a rotor case 110, a polygon mirror 120, and a bonding part 130.

The rotor case 110, fixed on a rotation shaft to be rotated, may be formed with a step part formed on an outer circumferential portion so that the polygon mirror 120 is mounted on the top thereof

In addition, the rotor case 110 may preferably have a cup shape manufactured by a press method.

The rotor case 110 may be formed with a groove part (not shown) of which a bonding surface on which the polygon mirror 120 is mounted is filled with a bonding agent in order to fix the polygon mirror 120 mounted on the top thereof using the bonding part 130 to prevent the polygon mirror 120 from being detached.

The polygon mirror 120, which deflectively scans light beam emitted from a light source (not shown), is mounted on the top of the rotor case 110.

At this time, the polygon mirror 120 is a rectangular parallelepiped without an assembling hole in an inner diameter thereof, wherein an outer circumferential portion and edges of the polygon mirror 120 are in contact with a step part formed on an outer circumferential surface of the rotor case 110.

Although the number of edges (angles) of the polygon mirror 120 is not limited, the size of the polygon mirror 120 is increased in a case of a quadrangle or more, such that a quadrangular shape is most preferable.

As described above, the polygon mirror 120 of the scanner motor according to the present invention has a rectangular parallelepiped shape without an assembling hole therein, thereby making it possible to prevent defects and costs from occurring beforehand when forming an assembling hole in an inner diameter of the polygon mirror 120 according to the prior art and be easily mounted on the top of the rotor case 110.

In addition, the polygon mirror 120 of the scanner motor according to the present invention may be made of glass or plastic.

The bonding part 130 is a portion fixing between the rotor case 110 and the polygon mirror 120 using a bonding agent or an adhesive.

In other words, the polygon mirror 120 is mounted on the top of the rotor case 110, and between the rotor case 110 and the polygon mirror 120 that are in contact with the inner diameter of the step part formed on the outer circumferential surface of the rotor case 110 is fixed using a bonding agent or an adhesive.

After the polygon mirror 120 is mounted so that its edges are in internal contact with the inner diameter of the rotor case 110, the bonding part 130 applies a bonding agent between the edge portions of the polygon mirror 120 and the rotor case 110. The kinds of bonding agent and adhesive are not limited, but UV bonding or an adhesive may be used.

FIG. 2 is a partial cross-sectional view of a scanner motor according to a preferred embodiment of the present invention, wherein the rectangular parallelepiped shaped polygon mirror 120 is mounted on the top of the rotor case 110.

The plurality of bonding parts 130 are formed between the rotor case 110 and the polygon mirror 120 and the bonding parts 130 are generally formed between the edges of the polygon mirror 120 and the inner diameter of the rotor case 110.

As another embodiment, the bonding part 130 may have a groove part (not shown) formed on a bonding surface of the rotor case 110 to which the polygon mirror 120 is bonded, to mount the polygon mirror 120 on the top of the rotor case 110 by filling the groove part with an adhesive or a bonding agent.

The bonding part 130 is made by being filled with various kinds of adhesives or UV bonding agents and then being cured.

FIG. 3 is a partial enlarged view of a scanner motor according to a preferred embodiment of the present invention, wherein the bonding part 130 is formed by contacting the inner diameter of the rotor case 110 with the edge of the polygon mirror 120 and then bonding or attaching them.

The bonding part 130 may be made of various adhesive materials, such as a UV bonding agent or general adhesives. In addition, although the forming position and the number of bonding part 130 are not limited, it is preferable that the bonding part 130 is formed on each contact surface between the edge of the polygon mirror 120 and the rotor case 110 in order to prevent the rotor case 110 and the polygon mirror 120 from being detached at the time of rotating the motor.

The scanner motor according to the present invention having the configuration as described above includes the rectangular parallelepiped shaped polygon mirror 120 without an assembling hole and the bonding part 130 formed between the rotor case 110 and the polygon mirror to simplify the manufacturing process of the polygon mirror 120 and improve the freedom degree in the manufacturing method, thereby reducing costs.

The scanner motor according to the preferred embodiments of the present invention includes the rectangular parallelepiped shaped polygon mirror without an assembling hole and the bonding part formed between the rotor case and the polygon mirror to simplify the manufacturing process of the polygon mirror and improve the freedom degree in the manufacturing method, thereby reducing costs.

Therefore, it is possible to reduce defects generated when forming a hole in the polygon mirror according to the prior art, remarkably reduce manufacturing time, and improve product reliability.

Although the preferred embodiments of the present invention have been disclosed for illustrative purposes, they are for specifically explaining the present invention and thus a scanner motor according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A scanner motor, comprising:
a rotor case fixed on a rotation shaft to be rotated;
a polygon mirror mounted on a top of the rotor case; and
a bonding part formed between the rotor case and the polygon mirror to fix the polygon mirror on the rotor case.

2. The scanner motor as set forth in claim 1, wherein the polygon mirror has a rectangular parallelepiped shape.

3. The scanner motor as set forth in claim 1, wherein the rotor case is formed with a step part, the step part being formed on an outer circumferential portion so that it corresponds to an outer circumferential portion of the polygon mirror.

4. The scanner motor as set forth in claim 3, wherein edges of the polygon mirror are in contact with the step part of the rotor case.

5. The scanner motor as set forth in claim 1, wherein the bonding part is applied with a bonding agent or an adhesive.

6. The scanner motor as set forth in claim 1, wherein the polygon mirror is made of glass or plastic.

7. The scanner motor as set forth in claim 1, wherein the rotor case is formed with a groove part in which the bonding agent is filled so that the polygon mirror is fixed on the contact surface with the polygon mirror.
